(19) United States
(12) Patent Application Publication
(10) Pub. No.: US 2018/0128048 A1
(43) Pub. Date: May 10, 2018

(54) ACTUATING DEVICE FOR MOVING A BARRIER

(71) Applicant: NICE S.p.A., Oderzo (IT)

(72) Inventor: Lucio PINESE, Treviso (IT)

(21) Appl. No.: 15/552,460

(22) PCT Filed: Feb. 17, 2016
(86) PCT No.: PCT/EP2016/053316

§ 371 Date: Aug. 21, 2017

(30) Foreign Application Priority Data
Feb. 23, 2015 (IT) TV2015A000033

(51) Int. Cl. E06B 9/72

(52) U.S. Cl. CPC E06B 9/72; E06B 2009/6809

(57) ABSTRACT

An actuating device for moving a barrier comprising a gear motor adapted to transmit a rotary motion to a tubular support, solidly connected to said barrier and rotating with respect to a fixed support.

The actuating device comprises improved regulation means of the end of run positions of the gear motor, which are easily usable even by an unskilled user.

The present invention relates to an actuating device for moving a barrier.

The use of actuating devices for automatic moving barriers, such as blinds, shutters, main doors, gates or the like, is widely known.

These devices in general comprise a gear motor capable of activating a kinematic thrust mechanism, operatively connected to a barrier to be moved.

Typically, in conventional actuating devices, the gear motor is deactivated by the respective control unit when reaching a predefined end of run position. In this way, it is possible to regulate the movement of the barrier, according to needs.

Generally, the end of run positions of the gear motor are established during installation of the actuating device.

To define and store an end of run position, the installer executes, by connecting a computer to the control unit, a set-up procedure, during which the gear motor is activated with known operating modes of “dead man” type.

During this set-up procedure, a measuring device of the control unit (for example an encoder) stores the number of revolutions executed by the gear motor before the barrier reaches a desired position as end of run position.

The measurement data detected (indicative of the end of run position desired for the gear motor corresponding to a given desired position for the barrier) are appropriately stored in the control unit, which uses them to regulate operation of the gear motor during free activation thereof.

The set-up procedure described above is executed for each end of run position desired for the gear motor.

As is known, this procedure is relatively lengthy and laborious to execute and must be performed by skilled personnel.

It is particularly tedious and costly when wishing to finely regulate the end of run position of the gear motors of a plurality of actuating devices already installed, as in the case of wishing to align the maximum opening positions of a plurality of roll-up barriers of a building (for example, because they are placed side-by-side with one another).

Unfortunately, the actuating devices currently available do not allow regulation (in particular fine regulation) of the end of run positions of the gear motor without executing the set-up procedure described above.

This represents a considerable disadvantage, particularly in the case in which a large number of barriers to be operationally managed are installed.

This problem is even more critical in view of the fact that, as is known, in applications such as blinds, shutters or roller shutters in general, the set end of run positions can often be subject to changes owing to settling of the roller shutter, or owing to atmospheric conditions (thermal dilation caused by exposure to the sun or to frost), or to wear on the system, thus making updating necessary.

A known example of actuating device for moving a barrier is described in WO20013/098108A1.

The main aim of the present invention is to provide an actuating device for moving a barrier that enables the problems mentioned above to be solved or mitigated.

Within this aim, an object of the present invention is to provide an actuating device having an overall structure that is relatively simple and has a limited size.

A further object of the present invention is to provide an actuating device that is relatively simple to install.

A further object of the present invention is to provide an actuating device that is easy to manufacture on an industrial scale, at competitive costs.

This aim, and said and other objects which will be more apparent below, are achieved by an actuating device for moving a barrier, according to the definition in claim 1 set forth below.

In general, the actuating device of the invention comprises a tubular supporting element, which is solidly connected with a barrier to move and rotating with respect to a fixed support, about a rotation axis.

The actuating device of the invention further comprises a gear motor configured to transmit a rotary motion to said tubular supporting element and a head portion, solidly connected with said fixed support, wherein said tubular supporting element is operatively coupled with said head portion so as to be free to rotate about said rotation axis.

The actuating device of the invention further comprises regulation means of an end of run position of said gear motor, which comprise a control unit adapted to control the operation of said gear motor and command means that can be manually activated and are adapted to provide, when activated, command signals to said control unit.

Said control unit is configured to provide control signals to said gear motor, in response to said command signals, when said gear motor is in proximity of or at an end of run position, so that said gear motor executes a rotation with a predefined angle and reaches a new end of run position.

Further characteristics and advantages of the present invention will be more apparent from the description of preferred, but not exclusive, embodiments of the actuating device according to the invention, shown by way of non-limiting example in the accompanying drawings, wherein:

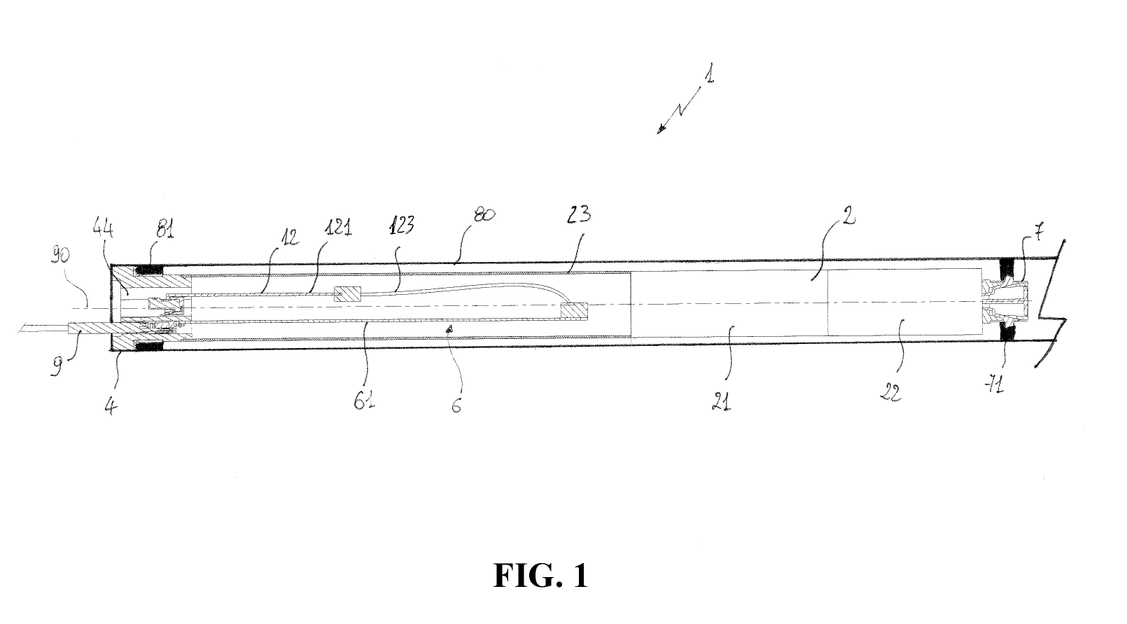

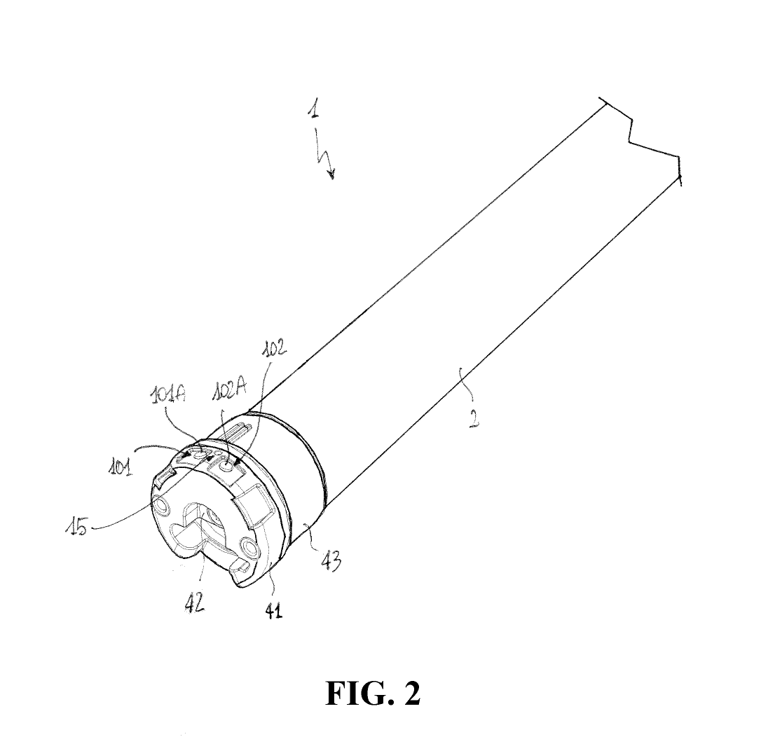

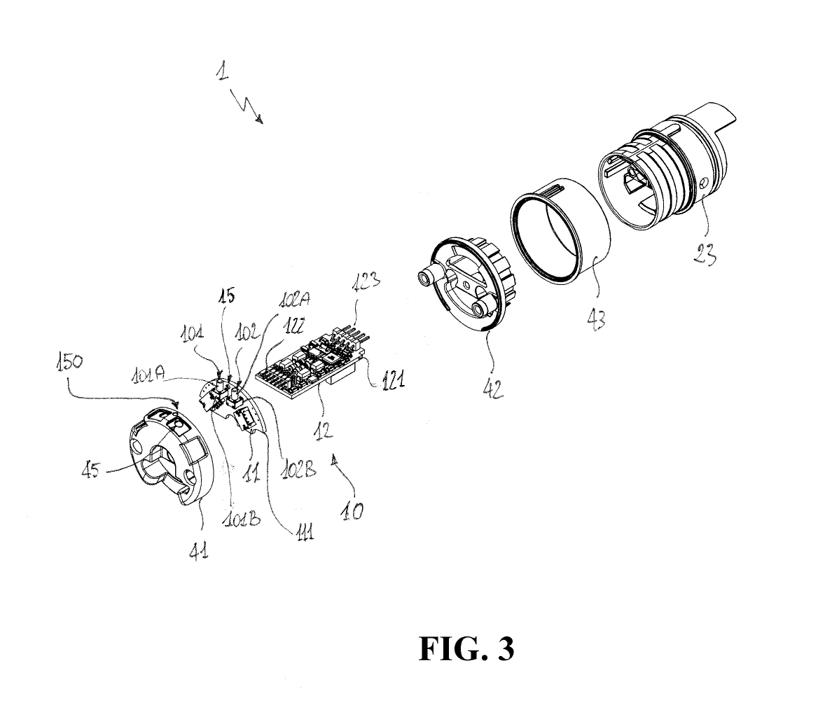

FIGS. 1-3 partially show, schematically, some exploded and sectional views of a portion of the actuating device, according to the present invention, in an embodiment thereof;

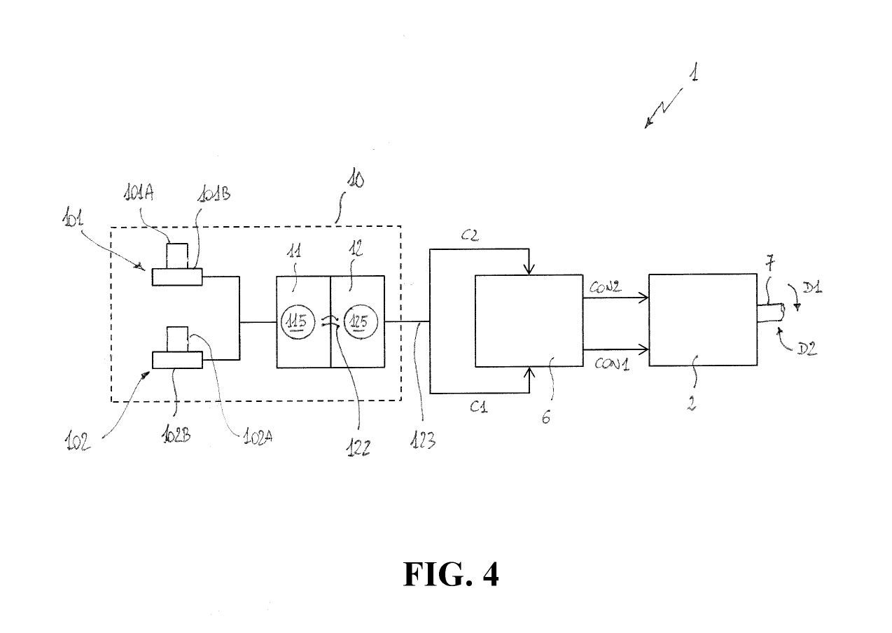

FIG. 4 schematically shows the operation of the actuating device of FIGS. 1-3.

With reference to the aforesaid figures, the present invention relates to an actuating device 1 for moving a barrier (not illustrated).

The actuating device 1 is particularly suitable for activating roller barriers, such as a blind, a shutter or the like and will be described, for simplicity, with reference to this type of use.

However, this is not intended to limit the scope of the present invention.

The actuating device 1 can be used, without significant changes in construction, also for the activation of barriers of different type, such as main doors, gates or the like.

The actuating device 1 comprises a tubular supporting element 80 solidly connected to the barrier to be activated and rotating with respect to the fixed support, about the rotation axis 90.

In the case in which the barrier to be activated is a roller barrier, the support element 80 can advantageously be composed, as illustrated in FIG. 1, of a roller tube.

In the case in which the barrier to be activated is a gate or main door, the support element 80 can be composed of an upright to support this latter or of other parts of the automation system and/or of the gate.

The actuating device 1 comprises a gear motor 2 intended to rotate about a rotation axis and to transmit a rotary motion to the tubular supporting element 80.

The gear motor 2 comprises an output shaft 7 operatively coupled with the tubular supporting element 80 by means of mechanical means of known type, for example by means of a pulley 71.

Preferably, the rotation axis of the gear motor 2 (i.e. of its output shaft 7) coincides with the rotation axis 90 of the tubular supporting element 80.

Preferably, the gear motor 2 has a tubular structure.

Preferably, the gear motor 2 comprises a containment casing 23, integral with a fixed support (not shown).

The gear motor 2 can be of conventional type.

Preferably, it comprises an electric motor 21, a mechanical speed reducer 22 operatively coupled to the electric motor, and to other accessory members of known type (for example a braking device), positioned inside the containment tube 23.

The gear motor 2 is configured to transmit a rotary motion to the tubular supporting element 80.

Preferably, the gear motor 2 is positioned in the space inside the tubular supporting element 80, which is arranged coaxially with the containment casing 23 of the gear motor and positioned outside this latter.

The actuating device 1 comprises a head portion 4, solidly connected to the fixed support (not shown).

The head portion 4 is operatively coupled to the support element 80, so that that this latter is rotatingly associated and substantially coaxial therewith.

For this purpose, a further pulley 81, solidly connected to the tubular support 80, is rotatingly associated with a connection sleeve 43 of the head portion 4.

The head portion 4 is solidly connected to the containment casing 23 of the gear motor, due to the connection sleeve 43 and other mechanical means of known type (not shown).

Preferably, the head portion 4 comprises a pair of shaped portions 41, 42 mutually coupled so as to define an internal cavity 44.

The shaped portions 41, 42 can be solidly connected with each other and with the fixed support by mechanical means of known type, for example screws or brackets (not shown).

The actuating device 1 comprises a control unit 6 configured to regulate operation of the gear motor 3, and more in general, operation of the actuating device 1.

Preferably, the control unit 6 is arranged on a circuit board 61 housed inside the containment casing 23 of the gear motor and advantageously fastened to the head portion 4.

In order to control the gear motor 2, the control unit 6 advantageously generates a series of control signals.

Preferably, the control unit 6 comprises at least one digital processing device, for example a microprocessor. The control unit 6 advantageously executes a series of software instructions to provide the control signals intended to regulate operation of the gear motor 2.

The control unit 6 can also comprise other control and measuring devices or circuits necessary to regulate operation of the actuating device 1, for example an encoder (not shown) to measure the revolutions of the gear motor 3 (or its angular position).

Advantageously, the actuating device 1 is operatively associated (preferably at the head portion 4) with a supply cable 9, intended to supply electrical power to the control unit 6, to the gear motor 3 and to all the other electrical/electronic devices of the actuating device 1.

According to the invention, the actuating device 1 comprises regulation means 6, 10 of the end of run positions of the gear motor 2.

Obviously, each end of run position of the gear motor 2 corresponds to a given desired position for the barrier moved by the gear motor.

The aforesaid regulation means comprise the control unit 6 of the actuating device 1 and command means 10, which can be manually activated by a user.

When they are manually activated, the command means 10 provide command signals C1, C2 to the control unit 6.

In response to the command signals C1, C2, in the case in which the gear motor 2 is close to or at an end of run position, the control unit 6 provides control signals CON1, CON2 to the gear motor 2 so that this latter executes a rotation with a predefined angle, about its rotation axis, reaching a new end of run position.

An important aspect of the present invention consists in the fact that the control unit 6 is configured so as to respond to a direct command C1, C2 coming from the command means 10.

In response to the signals C1, C2, the control unit 6 automatically provides the control signals CON1, CON2 to the gear motor 2 to shift this latter to a new end of run position, executing a predefined rotation movement.

Therefore, when the command means 10 are activated, the control unit 6 automatically updates the end of run position of the gear motor 2, rotating this latter by a predefined angle to reach a new end of run position.

The regulation means 6, 10 therefore allows execution of updating of the end of run positions of the gear motor, without the need to execute any complex and laborious set-up procedure, as is the case in known devices.

Preferably, activation of the command means 10 causes a response from the control unit 6, only if the gear motor 2 is close to or at an end of run position.

Preferably, the control unit 6 does not generate the control signals CON1, CON2, if the gear motor 2 is in a position different from a position close or coinciding with an end of run position.

In this way, it is configured not to react automatically to command signals C1, C2 sent that are generated following an accidental activation of the command means 10 with the gear motor 2 far from an end of run position.

Advantageously, the control unit 6 automatically stores data (advantageously measured by means of the aforesaid encoder) indicative of the new end of run position of the gear motor 2, reached after a predefined rotation of this latter.

Preferably, the control unit 6 is configured so that storing of data is regulated by a time-out mechanism.

In particular, the control unit 6 stores data indicative of the new end of run position, in the case in which it receives no further command signals C1, C2 in a predefined time interval.

Advantageously, in the case in which it receives further command signals C1, C2 before the end of the aforesaid predefined time interval, the control unit 6 generates further control signals CON1, CON2 for the gear motor 2 so that this latter reaches a further new end of run position, executing a further rotation with predefined angle.

The regulation means 6, 10 are preferably configured to allow execution of a micro-regulation of the end of run positions of the gear motor 2.

Preferably, the control unit 6 is configured to provide, in response to command signals C1, C2, control signals CON1, CON2 for the gear motor 2 so that this latter executes a rotation with a predefined angle in the interval between 0.5° and 5° (value referred to the encoder used to read the angular position of the gear motor).

Preferably, the gear motor 2 executes a rotation with a predefined angle of 1° or of 2°.

Preferably, the command means 10 comprise one or more micro-switches 101, 102 that can be manually activated by the user.

Preferably, the micro-switches 101, 102 are housed in the space inside the head portion 4, defined by the coupled shaped portions 41, 42.

The micro-switches 101, 102 can be of known type.

Preferably, each of the micro-switches 101, 102 comprises a button 101A, 102A operatively associated with a base 101B, 102B at which appropriate electrical contacts (not shown) are arranged.

Preferably, the micro-switches 101, 102 are positioned at the head portion 4 of the actuating device 1.

Preferably, the micro-switches 101, 102 are arranged so that the respective buttons 101A, 102A protrude from the head portion 4.

For this purpose, the buttons 101A, 102A are preferably housed inside appropriate through holes 45 obtained in the head portion 4.

Preferably, the command means 10 comprise electronic means 11, 12, electrically connected with the micro-switches 101, 102 and configured to generate the command signals C1, C2, when the micro-switches 101, 102 are manually activated.

In embodiments of the present invention (not shown) the micro-switches 101, 102 could however be electrically connected directly with the control unit 6, without the use of the electronic means 11, 12.

Preferably, the command means 10 comprise first electronic means 11.

Preferably, the electronic means 11 comprise one or more electronic interface circuits 115 operatively connected to the switches 101, 102, in particular to the electrical contacts thereof (FIG. 4).

Preferably, the electronic means 11 are arranged on a dedicated circuit board 111, which is advantageously housed in the space inside the head portion 4 and fixed thereto.

Advantageously, the circuit board 111 also acts as mechanical support for the micro-switches 101, 102.

Preferably, the command means 10 comprise second electronic means 12, operatively connected to the first electronic means 11 and to the control unit 6.

Preferably, the electronic means 12 comprise one or more control devices 125 operatively connected with the interface circuits 115 of the electronic means 11.

The control devices 125 can comprise at least one digital processing device (for example a microprocessor) or other dedicated control or processing circuits.

Preferably, the electronic means 12 are arranged on a dedicated circuit board 121, which is advantageously housed in the space inside the gear motor 2, defined by the containment casing 23, and is fixed to the head portion 4.

Advantageously, the circuit board 121 can house further electronic circuits or devices not comprised in the command means 10 but necessary for the operation of the actuating device 1, such as a radio transmission module, one or more Wi-Fi modules, and so forth.

The circuit boards 111, 121 and 61 can be operatively connected to one another by connection means 122, 123 of known type.

In embodiments of the present invention (not shown), the electronic means 11 and 12, and optionally also the control unit 6, could however be arranged on a single dedicated circuit board.

Advantageously, the regulation means 6, 10, 11 and 12 can be incorporated in a single box or station located outside the gear motor, connected with this latter to command its movements.

According to a preferred embodiment of the invention, shown in the aforesaid figures, the regulation means 6, 10 are arranged so as to allow regulation of the end of run positions of the gear motor 2 causing this latter to rotate (with predefined angles of rotation) according to opposite directions of rotation.

Preferably, the command means 10 comprise a first and second micro-switch 101, 102.

Preferably, the electronic means 11, 12 are configured to generate first command signals C1, when the first micro-switch 101 is manually activated.

Preferably, the electronic means 11, 12 are configured to generate second command signals C2, when the second micro-switch 102 is manually activated.

Preferably, the control unit 6 is configured to provide, in response to command signals C1, in the case in which the gear motor 2 is close to or at an end of run position, first control signals CON1 for the gear motor 2 so that this latter executes a rotation with a predefined angle in a first direction D1.

The first direction D1 of rotation of the gear motor 2 can, for example, correspond to a rolling up or opening movement of the barrier.

Preferably, the control unit 6 is configured to provide, in response to command signals C2, in the case in which the gear motor 2 is close to or at an end of run position, second control signals CON2 for the gear motor 2 so that this latter executes a rotation with a predefined angle according to a second direction D2, opposite the first direction D1.

The second direction D2 of rotation of the gear motor 2 can, for example, correspond to a rolling down or closing movement of the barrier.

Preferably, the command means 10 comprise visual signalling means 15 configured to provide visual signals indicative of activation of the micro-switches 101, 102.

Preferably, the visual signalling means 15 comprise at least one LED device and one or more electronic drive circuits.

Preferably, the visual signalling means 15 are arranged at the head portion 4 of the actuating device 1.

Preferably, the LED device 15 is housed inside an appropriate through hole 150 obtained in the head portion 4.

Preferably, the visual signalling means 15 are housed on the circuit board 111, described above.

In practice, it has been seen how the actuating device 1 according to the present invention enables the intended aim and objects to be achieved.

Due to the regulation means 6, 10, in the actuating device 1 it is possible to regulate (preferably finely) the end of run positions of the gear motor 2, without executing complicated set-up procedures, described above.

To execute this regulation, the user must take the gear motor 2 at or close to the end of run position to be updated, activating it normally.

At this point, the user must simply press the micro-switch 101 or the micro-switch 102 so that the gear motor 2 moves automatically to a new end of run position, by means of a predefined angular rotation (corresponding to a translatory or angular shift of the barrier to be moved).

If the new end of run position (corresponding to a given position of the barrier) is the one desired, the user does not need to do anything else. The control unit 6 will automatically store the new end of run position after a predefined time interval.

If the new end of run position is still not the position desired, the user must press the micro-switch 101 or the micro-switch 102 again, so that the gear motor 2 shifts to a new further end of run position.

Obviously, the operating cycle described above can be executed several times, until reaching the desired end of run position.

From the above, it is evident that regulation of the end of run position can be executed in a simple and intuitive manner, with considerable operating flexibility.

For example, regulation can be executed incrementally, activating a same micro-switch 101 or 102 several times, or in a more complex manner, activating the micro-switch 101 or the micro-switch 102, as required.

The actuating device 1 is characterized by being very easy and practical to use, even by unskilled personnel.

The actuating device 1 has a relatively simple structure, advantageously of tubular type in which the head portion 4, the control unit 6, the gear motor 2 and the command means 10 are advantageously housed, at least partially, in the inner volume defined by the support tube 80. It therefore has a relatively small size and is easy to install.

The actuating device 1 has a substantially modular structure, relatively simple and inexpensive to manufacture and to assemble on an industrial scale.

On the basis of the description provided, other characteristics, modifications or improvements are possible and evident to a person skilled in the art. These characteristics, modifications and improvements should therefore be considered part of the present invention. In practice, the materials used, the dimensions and contingent shapes can be any according to requirements and to the state of the art.

1. An actuating device (1) for moving a barrier, comprising:
a tubular supporting element (80), solidly connected with said barrier and rotating with respect to a fixed support, about a rotation axis (90);
a gear motor (2) configured to transmit a rotary motion to said tubular supporting element;
a head portion (4), solidly connected with said fixed support, said tubular supporting element (80) being operatively coupled with said head portion so as to be free to rotate about said rotation axis;
regulation means (6, 10) of an end of run position of said gear motor;
characterised in that said regulation means comprise a control unit (6) adapted to control the operation of said gear motor and command means (10) that can be manually activated and are adapted to provide, when activated, command signals (C1, C2) to said control unit, said control unit being configured to provide in response to said command signals, when said gear motor is in proximity of or at a given end of run position, control signals (CON1, CON2) to said gear motor, so that said gear motor executes a rotation with a predefined angle and reaches a new end of run position.

2. The actuating device, according to claim 1, wherein said control unit (6) is configured to store data indicative of the new end of run position of said gear motor, if it does not receive command signals (C1, C2) in a predefined time interval.

3. The actuating device, according to claim 1, wherein said command means (10) comprise:
at least a micro-switch (101, 102) that can be manually actuated;
electronic means (11, 12) configured to generate said command signals (C1, C2), when said at least a micro-switch is manually actuated.

4. The actuating device, according to claim 3, wherein said command means (10) comprise a first a micro-switch (101) and a second a micro-switch (102), said electronic means (11, 12) being configured to generate first command signals (C1), when said first micro-switch is manually actuated, said electronic means (11, 12) being configured to generate second command signals (C2), when said second micro-switch is manually actuated.

5. The actuating device, according to claim 4, wherein said control unit (6) is configured to provide, in response to said first command signals (C1), first control signals (CON1) to said gear motor, so that said gear motor executes a rotation with a predefined angle according to a first direction (D1), and is configured to provide, in response to said second command signals (C2), second control signals (CON2) to said gear motor, so that said gear motor executes a rotation with a predefined angle according to a second direction (D2), opposite to said first direction.

6. The actuating device, according to claim 3, wherein said electronic means comprise first electronic means (11) operatively connected to said at least a micro-switch (101, 102), said first electronic means comprising at least an interface circuit (115) operatively associated to said at least a micro-switch.

7. The actuating device, according to claim 6, wherein said electronic means comprise second electronic means (12) operatively connected to said first electronic means (11), said second electronic means comprising at least a control device (125) operatively associated to said at least an interface circuit (115).

8. The actuating device, according to claim 3, wherein said at least a micro-switch (101, 102) is positioned at the head portion (4) of said actuation device.

9. The actuating device, according to claim 8, wherein said at least a micro-switch (101, 102) is arranged so that a button (101A, 102A) of said at least a micro-switch protrudes from said head portion (4).

10. The actuating device, according to claim 1, wherein said gear motor (2) executes a rotation with a predefined angle comprised in the interval between 0.5° and 5°.

11. The actuating device, according claim 10, wherein said gear motor (2) executes a rotation with a predefined angle of 1° or 2°.
